(19) United States
(12) Patent Application Publication
(10) Pub. No.: US 2005/0279886 A1
(43) Pub. Date: Dec. 22, 2005

(54) Jittie Blocker / Shield

(75) Inventor: Edward Willis, Holland, OH (US)

Correspondence Address: EDWARD WILLIS, 7730 PILLIOD ROAD, HOLLAND, OH, 43528-8077, US

(73) Assignee: Mr. Edward Willis, Holland, OH (US)

(21) Appl. No.: 10/709,233

(22) Filed: Apr. 22, 2004

(51) Int. Cl. B64D 11/00

(52) U.S. Cl. 244/118.5

(57) ABSTRACT

An aircraft cockpit reinforced, stationary dividing wall system that completely separates the Pilots cockpit flight deck from the passengers compartment. Additionally, this stationary dividing wall shall be an engineered unit consisting of Titanium studding, thick Titanium plates, attached on each side with an outer thick layer of Kevlar and a material called spectra. This stationary dividing wall shall be designed to maintain complete separation of the passengers from the aircraft navigation personnel. The lightweight, solid, bulletproof, stationary interior enclosing wall system, wherein with relatively few components, most of which can be formed from titanium sheet stock. A wide variety of interior full height walls can be constructed, thus avoiding the necessity of the manufacture and inventory of a large number of parts. In the preferred form, a verticalness panel is constructed having rolled formed recessed edge that includes a folded flange of special configuration uniformly spaced, so that the wall studding and panels may readily be secured with rivets. The studs would be attached to the frame assembly that support the fuselage skin panels and would become a part of said frame structure. A nonwoven mix of Kevlar and a material called Spectra would accommodate a wide variety of surface finishes and provide and appearance cover for stopping bullets and similar high impact force projectiles.

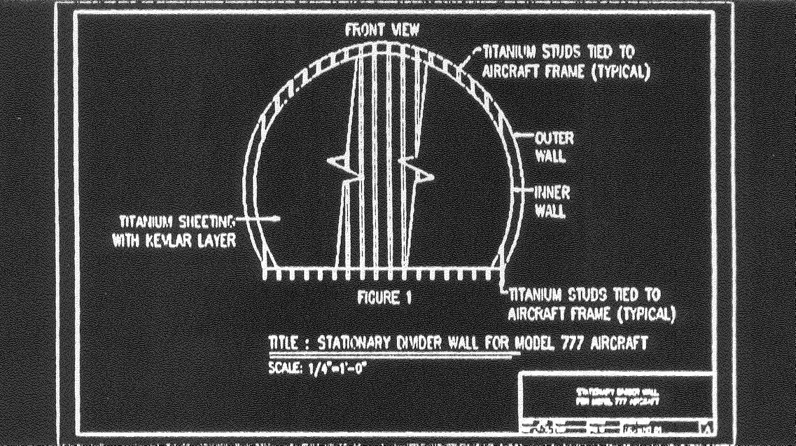

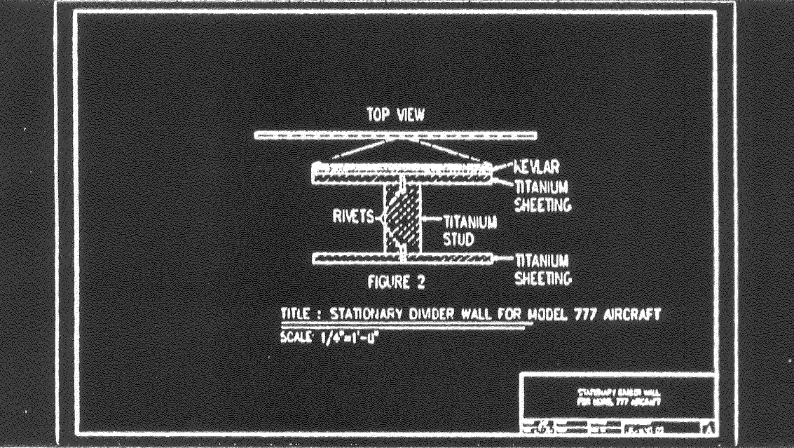

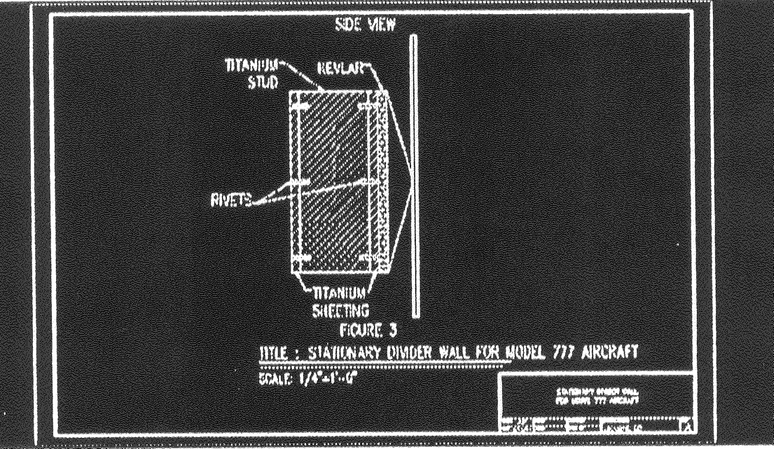

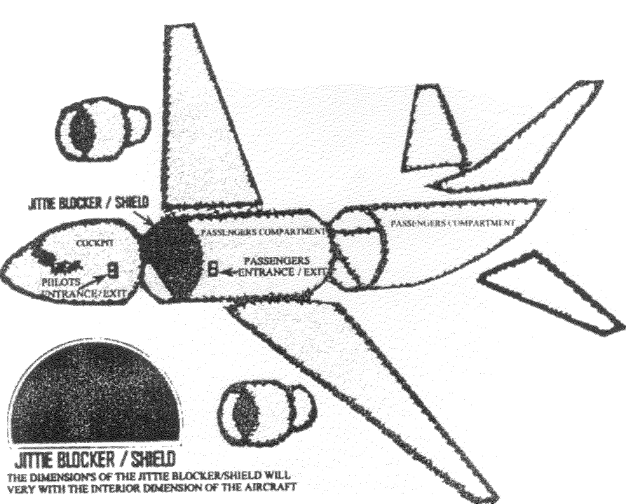

### DETAILED DESCRIPTION

The present invention relates generally to the field of technology involving shielding for protecting against encroachment and high impact force projectiles. More particularly, the invention relates to an aircraft stationary, interior protective, vertical enclosing wall system that is located in the fuselage forward section, behind the cockpit flight deck and in front of the passenger's compartment. The wall, in architecture, protective, enclosing, or dividing vertical structure with supporting titanium studding on that which is secured, titanium sheets and Kevlar with a material called spectra uniformly spaced on it periphery. The titanium studding spaced 16″o/c, shall be connected above and on the sides to the aircrafts fuselage members and 1 ft. below to the floor supporting members. The design employs a multi-layer approach using Kevlar and a material called spectra, and titanium to provide strength and lightweight. The stationary dividing wall has an estimated density of 4 gm/cm³⁻260 lb/ft³. This permanent wall system shall extend perpendicular to the longitudinal cabin direction from the aircraft roof supporting members and 1 ft. below the floor supporting members. Its thickness is determined by the material, height, and stress. The vertical studding, and its enclosed protective wall system, may be of titanium or aluminum or of lightweight alloy steel in combination with one or more of the preceding materials. The wall serves two functions; (1) the wall is used as a support, for the floor and roof. (2) It totally separates and gives maximum protection, to the pilots in the cockpit flight deck, against any person or persons, in the passengers compartment of the aircraft, from encroaching and commandeering the aircraft. Layers of bulletproof materials such as a nonwoven mix of Kevlar and a material called Spectra, a high performance polyethylene material that is both stiff and light, and using adhesive designed to provides a hermetic, semi-elastic bond attaches the Kevlar and a material called spectra to the titanium would cover the periphery of the titanium wall system, to ensure that if a bullet was fired from a weapon it wouldn't penetrate, deflect or ricochet off the wall and strike someone. The concept of protective shielding for resisting or repelling the penetration of a bullet or similar high impact force projectile is well known in the garment known as a bullet-proof vest which is often worn by law enforcement security personnel. Easy access to commercial pilots by the flying public will be eliminated with the proper stationary dividing wall installation. Furthermore, this stationary dividing wall has been designed to provide resistance to substantial arms fire including Class 1 through Class 5 threats. Pilots and passengers would be totally isolated from each other and would use separate entrance/exit doors. There shall be two dividing wall designs, one for new aircraft installation, one for existing aircraft installation. Generally, the dividing wall shall be attached to the aircraft fuselage frame with standard connectors specifically designed for aircraft erection. Since the dividing wall is fixed, cockpit flight deck cabin access modifications are required. Additional modifications will be necessary for food and for restrooms. The cockpit flight deck cabin of new aircraft will be designed to incorporate the new layout. Each dividing wall shall be designed and custom built to fit exactly within a specified aircraft.

1. What I claim as my invention is the JITTIE (Oust In Time To Interrupt Entry) Blocker Shield stationary interior protective wall system. A designed lightweight, solid, bullet-proof, stationary studding enclosing wall system that totally isolate the cockpit flight deck area from the passenger's compartment of the aircraft. The relative ease to which the hijackers of September 11^{th} gain access to the cockpit flight deck cabin demonstrates the need for dividing the cockpit flight deck cabin and the passenger compartments. Pilots wouldn't have to carry loaded weapons or stun guns for protection. Passengers would fill much more secure and their confidence level restored, knowing no one can encroach the cockpit flight deck area, kill the pilots, and commandeer the aircraft. Although lightweight armor isolates the control room of other vessels, this design provides commercial aircraft flight cabin protection. This stationary dividing wall is designed for installation into existing or into new aircraft
